(19) United States
(12) Patent Application Publication
(10) Pub. No.: US 2026/0177252 A1
(43) Pub. Date: Jun. 25, 2026

(54) Heated Deck Board System

(71) Applicant: Michael Vlcek, Littleton, CO (US)

(72) Inventor: Michael Vlcek, Littleton, CO (US)

(21) Appl. No.: 19/398,142

(22) Filed: Nov. 24, 2025

Related U.S. Application Data
(60) Provisional application No. 63/735,998, filed on Dec. 19, 2024.

(51) Int. Cl. F24D 13/02; F24D 19/10; H05B 3/56

(52) U.S. Cl. CPC F24D 13/024; F24D 19/1096; H05B 3/56; F24D 2200/08

(57) ABSTRACT

A heated deck board system is provided. The device is comprised of at least one base board dimensioned to match standard deck construction parameters and configured for secure attachment to deck joists through integrated countersunk apertures. Each baseboard comprises one or more channels that house heating elements. The heating element is comprised of a waterproof conductive material. The baseboard also comprises recessed expansion sections to allow for thermal displacement of the heating element. The system further comprises a removable cover panel that overlays the base board and is secured via mechanical engagement features such as snap-fit or interlocking edges. The cover panel is made from weather-resistant materials and may feature surface texturing for slip resistance and drainage channels to manage meltwater flow. The heating element is further electrically connected to a thermostat module comprising temperature sensors, wireless communication capability, and control circuitry.

### CROSS-REFERENCE TO RELATED APPLICATION

The present application claims priority to, and the benefit of, U.S. Provisional Application No. 63/735,998, which was filed on Dec. 19, 2024, and is incorporated herein by reference in its entirety.

### FIELD OF THE INVENTION

The present invention relates generally to the field of decking. More specifically, the present invention relates to a heated deck board system that prevents snow and ice buildup using embedded heating elements and is wirelessly controlled via a mobile app. Accordingly, the present disclosure makes specific reference thereto. Nonetheless, it is to be appreciated that aspects of the present invention are also equally applicable to other like applications, devices, and methods of manufacture.

### BACKGROUND

In many residential and commercial environments, outdoor decks serve as essential transition zones between interior spaces and the surrounding environment. These structures provide functional and recreational utility but present significant maintenance and safety challenges during the winter months. Specifically, the accumulation of snow and ice on deck surfaces creates hazardous walking conditions, increasing the likelihood of slip-related injuries. This condition is particularly problematic in high-traffic areas such as public walkways, commercial venues, and multi-unit residential properties. Manual snow removal methods, such as shoveling or applying chemical de-icers, are labor-intensive, time-consuming, and often inconsistent in efficacy. Furthermore, the use of de-icing chemicals may contribute to surface degradation and pose environmental concerns. Property owners may also be held liable for injuries resulting from untreated icy surfaces, increasing their legal and financial exposure. The limitations of existing deck maintenance solutions underscore the need for a more reliable, automated, and integrated approach to maintaining safe and accessible deck surfaces in cold climates.

Therefore, there exists a long-felt need in the art for a heated deck board system that can be installed on traditional decking material. There also exists a long-felt need in the art for a heated deck board system that can be operated both wirelessly and remotely. Moreover, there exists a long-felt need in the art for a heated deck board system that prevents snow and ice accumulation while maintaining structural compatibility with standard deck configurations.

The subject matter disclosed and claimed herein, in one embodiment thereof, comprises a heated deck board system. The device is comprised of at least one base board dimensioned to match standard deck construction parameters and configured for secure attachment to deck joists through integrated countersunk apertures. Each baseboard comprises one or more channels that house heating elements. The heating element is comprised of a waterproof conductive material. The baseboard also comprises recessed expansion sections to allow for thermal displacement of the heating element. The system further comprises a removable cover panel that overlays the base board and is secured via mechanical engagement features such as snap-fit or interlocking edges. The cover panel is made from weather-resistant materials and may feature surface texturing for slip resistance and drainage channels to manage meltwater flow. The heating element is further electrically connected to a thermostat module comprising temperature sensors, wireless communication capability, and control circuitry. The system is controllable via a mobile application that allows users to schedule heating cycles, set temperature targets, and store multiple control programs.

In this manner, the heated deck board system of the present invention accomplishes all the forgoing objectives and provides a deck surface that eliminates the need for manual snow removal, reducing injury risks, and enabling consistent surface heating through integrated and concealed heating components. The configuration of standard-sized base boards ensures compatibility with conventional deck framing, while embedded channels and expansion features accommodate the installation and operation of heating elements. The removable cover panels with anti-slip surfaces further provide a user-friendly and low-maintenance exterior layer that enhances safety and water drainage. The integration of a wireless thermostat module and mobile application interface further allows for remote scheduling and monitoring, addressing both convenience and energy efficiency. Overall, the heated deck board system provides a comprehensive solution to longstanding problems related to winter deck maintenance and user safety.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a heated deck board system. The system is designed to prevent the accumulation of snow and ice on outdoor decking surfaces, reducing the need for manual snow removal or chemical de-icing. This system further enhances safety by minimizing slip-related injuries and maintaining accessibility during adverse weather conditions.

The system is comprised of at least one base board manufactured in standard deck board dimensions to ensure compatibility with conventional deck framing systems. The baseboard is fastened to deck joists using at least one countersunk screw aperture positioned at regular intervals along the lateral edges. Each baseboard is further comprised of at least one channel. The channel may also include recessed expansion sections configured to allow for longitudinal displacement of a heating element. The heating element is comprised of a waterproof electrical conductor, such as a PTFE-jacketed resistance wire, self-regulating conductive polymer cable, or braided constant wattage heater.

A thermostat module is electrically connected to the heating element and includes a temperature regulation circuit, a temperature sensor, and a wireless communication module. The system is also comprised of a mobile application that enables users to schedule activation of the heating element, set heating durations, and define target operating temperatures.

A removable cover panel overlays the baseboard and serves as the visible deck surface. The cover panel is designed for tool-free installation and removal via opposing lips that engage recessed areas on each lateral edge of the base board. The top surface of the cover panel may include a textured finish to enhance slip resistance.

Accordingly, the heated deck board system of the present invention is particularly advantageous as it provides a deck surface that eliminates the need for manual snow removal, reducing injury risks, and enabling consistent surface heating through integrated and concealed heating components. The configuration of standard-sized base boards ensures compatibility with conventional deck framing, while embedded channels and expansion features accommodate the installation and operation of heating elements. The removable cover panels with anti-slip surfaces further provide a user-friendly and low-maintenance exterior layer that enhances safety and water drainage. The integration of a wireless thermostat module and mobile application interface further allows for remote scheduling and monitoring, addressing both convenience and energy efficiency. In this manner, the heated deck board system overcomes the limitations of existing decking known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded perspective view of one potential embodiment of a heated deck board system of the present invention in accordance with the disclosed architecture;

FIG. 2 illustrates a perspective view of base boards of one potential embodiment of a heated deck board system of the present invention in accordance with the disclosed architecture;

FIG. 3 illustrates a perspective view of one potential embodiment of a heated deck board system of the present invention in accordance with the disclosed architecture; and

FIG. 4 illustrates a graphical view of features of a mobile application of one potential embodiment of a heated deck board system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a heated deck board system that can be installed on traditional decking material. There also exists a long-felt need in the art for a heated deck board system that can be operated both wirelessly and remotely. Moreover, there exists a long-felt need in the art for a heated deck board system that prevents snow and ice accumulation while maintaining structural compatibility with standard deck configurations.

The present invention, in one exemplary embodiment, is comprised of a heated deck board system. The system is configured to inhibit the accumulation of snow and ice on outdoor decking surfaces, thereby reducing reliance on manual snow removal or chemical de-icing methods. By maintaining clear and safe surfaces, the system supports improved accessibility and reduces the risk of slip-related injuries during adverse weather conditions.

The system comprises at least one base board produced in standard deck board dimensions, allowing integration with conventional deck framing systems. The baseboard is secured to deck joists through multiple countersunk screw apertures positioned at regular intervals along the lateral edges. Each base board incorporates at least one channel, which may include recessed expansion sections designed to accommodate the longitudinal movement of an integrated heating element. The heating element is comprised of a waterproof electrical conductor, such as a PTFE-jacketed resistance wire, a self-regulating conductive polymer cable, or a braided constant wattage heater.

A thermostat module, electrically connected to the heating element, features a temperature regulation circuit, a temperature sensor, and a wireless communication module. Additionally, the system includes a mobile application that allows users to schedule the heating element's operation, adjust heating durations, and set target operating temperatures.

The baseboard is overlaid by a removable cover panel that functions as the visible deck surface. Designed for tool-free installation and removal, the cover panel engages with recessed areas on each lateral edge of the base board using opposing lips. The upper surface of the cover panel may be textured to enhance slip resistance.

As a result, the system eliminates the need for manual snow removal while reducing injury risks and ensuring uniform heat distribution through integrated, concealed heating components. The use of standard-sized baseboards further enables compatibility with conventional framing, and embedded channels with expansion features support efficient installation and performance of heating elements. The inclusion of removable, slip-resistant cover panels offers a low-maintenance, user-friendly exterior layer that promotes both safety and effective water drainage. In addition, the integration of a wireless thermostat module and mobile application interface further facilitates remote control, scheduling, and energy-efficient operation. As a result, the system overcomes the limitations of existing decking known in the art.

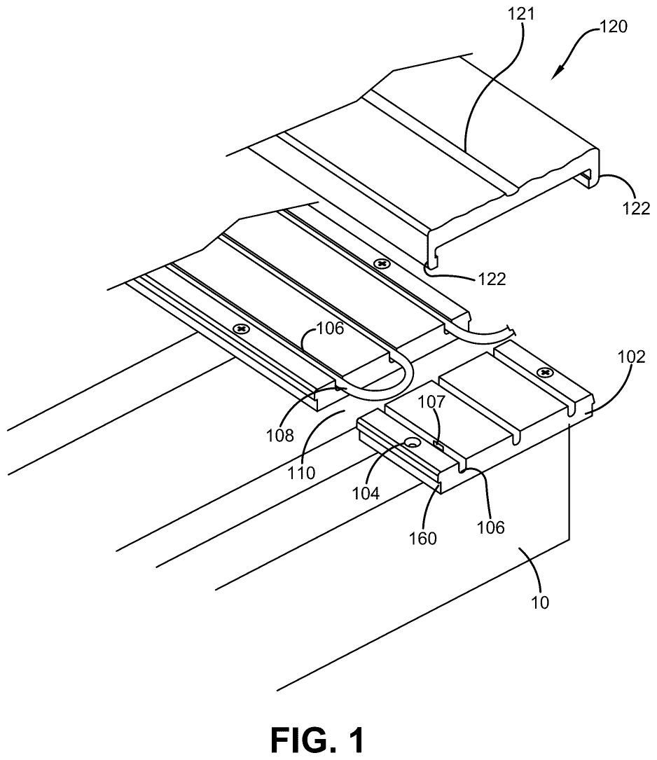

Referring initially to the drawings, FIG. 1 illustrates an exploded perspective view of one potential embodiment of a heated deck board system 100 of the present invention in accordance with the disclosed architecture. The heated decking board system 100 is configured to prevent the accumulation of snow and ice on outdoor decking surfaces, thereby eliminating the need for manual snow removal or chemical de-icing. This system 100 reduces the risk of slip-related injuries and maintains accessibility during inclement weather conditions. The system 100 may be deployed in residential patios, commercial rooftop decks, hospitality venues, public walkways, or transit platforms.

The system 100 may be comprised of at least one base board 102. The base board 102 may be manufactured in standard deck board dimensions, such as but not limited to widths between 4 and 8 inches and lengths between 6 and 20 feet, ensuring compatibility with conventional wood or metal deck framing systems. The base board 102 may be comprised of one or more materials such as but not limited to any combination of high-density polyethylene (HDPE), polypropylene composites, fiberglass-reinforced polymer (FRP), or engineered wood composites. The material selection may be selected in different embodiments for thermal conductivity, moisture resistance, UV stability, load-bearing capacity, and ease of manufacture.

The base board 102 may be fastened to deck joists 10 using at least one countersunk screw apertures 104, as seen in FIG. 1. A plurality of screw apertures 104 may be positioned at regular intervals along the lateral margins of the board 102 and may be chamfered or beveled apertures to accommodate flat-head fasteners.

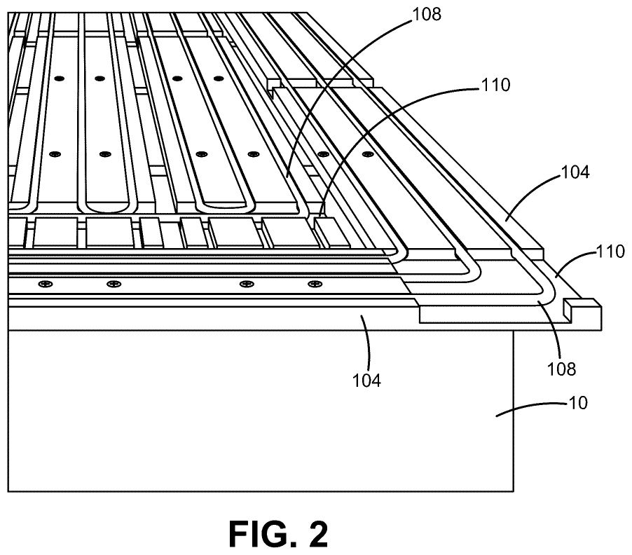

The base board 102 is further comprised of at least one channel 106, as seen in FIG. 1 and FIG. 2. Each channel 106 may extend longitudinally or in a serpentine pattern along the board 102. The cross-sectional geometry of the channel 106 may be circular, oval, trapezoidal, rectangular, etc. depending on the shape of the heating element 108. In one embodiment, the channel 106 may optionally be lined with an insulating layer 107 such as but not limited to a thermally conductive polymeric insert or aluminum foil layer to promote uniform heat distribution.

The base board 102 may also be comprised of one or more recessed expansion sections 110, as seen in FIG. 1 and FIG. 2. Each expansion section 110 may be configured as a flexible slack region or serpentine detour within the channel 106 that permits longitudinal displacement of the heating element 108. These sections 110 may vary in width and depth to accommodate different heating element 108 sizes and thermal expansion coefficients.

Multiple base boards 102 may be aligned and secured in parallel to the underlying deck structure to form the foundational layer of the decking system 100, as seen in FIG. 2. At least one rectangular base boards 102 may then be used in central zones, while mitered base boards 102 with angled ends 103 may be deployed along perimeter edges, transitions, or custom geometries. Mitered cuts may include angles ranging from 1 to 89 degrees and may be pre-molded or field-fabricated.

The heating element 108 may be comprised of but is not limited to a waterproof electrical conductor such as but not limited to any combination of a PTFE-jacketed resistance wire, self-regulating conductive polymer cable, or braided constant wattage heater.

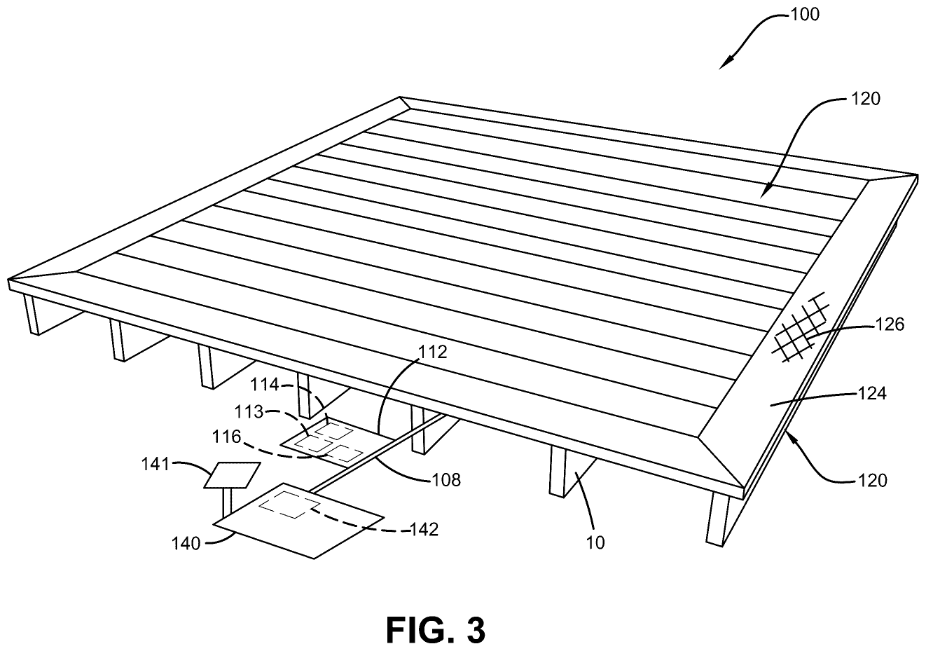

The system 100 may also be comprised of a thermostat module 112 that is electrically coupled to the heating element 108, as seen in FIG. 3. The thermostat module 112 may include a digital and/or analog temperature regulation circuit 113, an integrated temperature sensor 114, and a wireless communication module 116. The sensor 114 may be any combination of an NTC thermistor, RTD, or infrared proximity sensor embedded within or adjacent to the base board 102. The wireless module 116 may support protocols such as Wi-Fi, Bluetooth Low Energy (BLE), LoRaWAN, or Zigbee for secure communication with control devices.

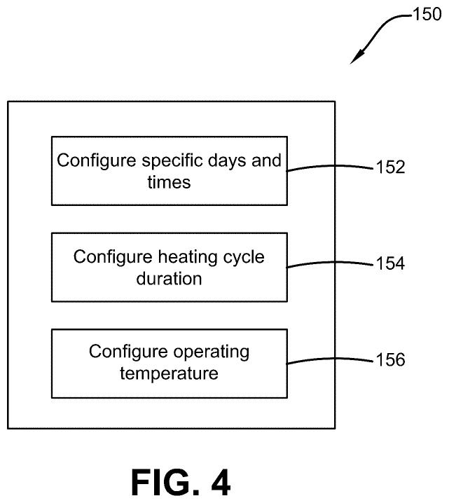

More specifically, in one embodiment the system 100 may be operatively connected to a mobile application 150, as seen in FIG. 4. The mobile application 150 may be configured to allow users to schedule activation of the heating element 108 for specific days and times [152], define the duration of each heating cycle [154], and set a target operating temperature for the heating element 108 [156]. The mobile application 150 may store multiple scheduled programs.

The system 100 may also be comprised of a removable cover panel 120 that overlays the base board 102, as seen in FIG. 3. The cover panel 120 may serve as the visible deck surface and may be designed for tool-free installation and removal. The panel 120 may include two opposing lips 122 that engage with recessed areas 160 formed into each lateral edge of the base board 102, as seen in FIG. 1. The engagement mechanism between the lips 122 and areas 160 may include but are not limited to snap-fit connections, male and female connections, etc.

The cover panel 120 may be made from materials such as but not limited to glass-filled polypropylene, foamed PVC, thermoplastic elastomers, etc. The top surface 124 of the cover panel 120 may include a texture 126 that enhances slip resistance, in one embodiment. The texture 126 may be configured as but is not limited to any combination of a stippled finish, cross-hatch pattern, grooved ribbing, or embedded abrasive grit. In one embodiment, the cover panel 120 may include integrated drainage channels 121 to direct meltwater away from high-traffic areas.

The system 100 may be powered via a centralized power module 140, as seen in FIG. 1. The power module 140 may be comprised of but is not limited to any combination of a step-down transformer, programmable control relay, and circuit protection features 142 such as time-delay fuses, arc fault interrupters, or ground fault circuit interrupters (GFCIs). In one embodiment, the module 140 receives power from at least one solar panel 141 of any type and configuration.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “heated deck board system” and “system” are interchangeable and refer to the heated deck board system 100 of the present invention.

Notwithstanding the forgoing, the heated deck board system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the heated deck board system 100 as shown in the FIGS. are for illustrative purposes only, and that many other sizes and shapes of the heated deck board system 100 are well within the scope of the present disclosure. Although the dimensions of the heated deck board system 100 are important design parameters for user convenience, the heated deck board system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A heated deck board system comprising:
a baseboard comprised of a channel;
a heating element positioned within the channel;
a thermostat module electrically coupled to the heating element; and
a cover panel removably attached to the baseboard.

2. The heated deck board system of claim 1, wherein the channel is comprised of an insulating layer.

3. The heated deck board system of claim 1, wherein the baseboard is comprised of an expansion section.

4. The heated deck board system of claim 1, wherein the baseboard is comprised of a screw aperture.

5. A heated deck board system comprising:
a baseboard comprised of a channel;
a heating element positioned within the channel;
a power module;
a thermostat module electrically coupled to the heating element; and
a cover panel removably attached to the baseboard.

6. The heated deck board system of claim 5 further comprised of a solar panel.

7. The heated deck board system of claim 5, wherein the heating element is comprised of a PTFE-jacketed resistance wire, a self-regulating conductive polymer cable, or a braided constant wattage heater.

8. The heated deck board system of claim 5, wherein the baseboard is comprised of a recessed area.

9. The heated deck board system of claim 8, wherein the cover panel is comprised of a lip.

10. The heated deck board system of claim 5, wherein a top surface of the cover panel is comprised of a channel.

11. The heated deck board system of claim 5, wherein a top surface of the cover panel is comprised of a texture.

12. A heated deck board system comprising:
a baseboard comprised of a channel;
a heating element positioned within the channel;
a power module;
a mobile application;
a thermostat module electrically coupled to the heating element; and
a cover panel removably attached to the baseboard.

13. The heated deck board system of claim 12, wherein the thermostat module comprises a temperature regulation circuit, a temperature sensor, and a wireless communication module.

14. The heated deck board system of claim 12, wherein the mobile application configures an activation of the heating element.

15. The heated deck board system of claim 12, wherein the mobile application configures a heating cycle duration of the heating element.

16. The heated deck board system of claim 12, wherein the mobile application configures a temperature of the heating element.

17. The heated deck board system of claim 12, wherein the base board is comprised of an expansion section.

18. The heated deck board system of claim 12, wherein the channel is comprised of an insulating layer.

19. The heated deck board system of claim 12 further comprised of a solar panel.

20. The heated deck board system of claim 12, wherein the power module is comprised of a step-down transformer or a programmable control relay.
